(19) United States
(12) Patent Application Publication
(10) Pub. No.: US 2015/0205674 A1
(43) Pub. Date: Jul. 23, 2015

(54) CATALOGING BACKUP DATA

(71) Applicant: HEWLETT-PACKARD DEVELOPMENT COMPANY, L.P., Houston, TX (US)

(72) Inventors: Albrecht Schroth, Boeblingen (DE); Bernhard Kappler, Boeblingen (DE); Harald Burose, Boeblingen (DE); Kalambur Venkata Subramaniam, Bangalore (IN)

(21) Appl. No.: 14/418,727

(22) PCT Filed: Oct. 31, 2012
(86) PCT No.: PCT/US12/62778

§ 371 Date: Jan. 30, 2015

(51) Int. Cl. G06F 11/14

(52) U.S. Cl. CPC G06F 11/1412; G06F 2201/84

(57) ABSTRACT

Methods and apparatus are disclosed to catalog backup data. An example method of cataloging backup data includes when a source server is offline, copying the backup data to a data repository from the source server. In response to completing copying of the backup data, the example method also includes putting the source server online. The example method also includes cataloging the backup data in the data repository when the source server is online to complete backup of the backup data to the data repository.

### BACKGROUND

Data backup allows restoring of original data at a later time. For example, when original data is lost or corrupted, it may be restored from backup data. To efficiently restore a file (or files) from backup data, a catalog entry for the file is created in a catalog. Catalog entries map the file or properties of the file to different versions of that file and the locations of the versions of the file in the backup data.

### BRIEF DESCRIPTION OF THE DRAWINGS

FIG. 1 illustrates an example data backup system that may be used to implement examples disclosed herein.

FIG. 2 is a detailed diagram of the example data backup system of FIG. 1.

FIG. 3 illustrates an example distributed data repository that may be used to distribute backup data to a plurality of storage servers.

FIG. 4 is a flowchart representative of machine readable instructions that may be executed to create backup data.

FIG. 5 is a flowchart representative of machine readable instructions that may be executed to catalog backup data.

FIG. 6 is a flowchart representative of machine readable instructions that may be executed to distribute backup data to multiple storage servers.

FIG. 7 is a block diagram of an example processing platform capable of executing the example machine readable instructions of FIGS. 4-6 to implement the example systems of FIGS. 1-3.

### DETAILED DESCRIPTION

A data backup process involves creating a copy or snapshot of data to be backed up during a data transfer process, and cataloging the backup data after the data transfer process. Prior backup systems place a data source (e.g., a computer or server to be backed up) offline during the data transfer process and the cataloging process, and do not place the data source back online until both processes are complete. Unlike prior systems, examples disclosed herein enable performing the data transfer while the data source is offline, and performing the cataloging after placing the data source back online.

During data backup processes, a data source server (e.g., a client server that is being backed up) is taken offline so that files cannot be modified by users or other processes while the data is copied to a data repository (e.g., where the backup data is stored during a data copy process). In this manner, a snapshot of a state of all the data in the data source at a particular point in time can be captured. This decreases the likelihood of backup data being unusable or corrupted due to users or processes modifying files during a backup process. That is, such file modifications could cause a data copy process to copy some old data and some new data for a file or files during data transfer of a backup process. During a cataloging process, the backup data is indexed for subsequent retrieval from the data repository. In prior systems that keep the data source offline while performing both the data copy process and the cataloging process, the data source is offline and inaccessible to clients for a relatively long time while both of the data transfer and cataloging processes are complete. This period of inaccessibility increases as the amount of data being backed up and cataloged increases. Unlike prior systems, examples disclosed herein shorten the amount of time that a data source is offline during a data backup process by putting the data source back online after copying the data, and completing the cataloging of the backup data while the data source is back online and accessible to clients. By performing the cataloging as a background process, it can be completed at a later time while making the data source available to clients more quickly than prior systems.

Examples disclosed herein may also be used to store backup data across multiple storage servers to increase access speeds when accessing backup data relative to access speeds of prior systems. In some examples, large data repositories may store several terabytes of information across multiple storage devices/servers. In some examples, different types of storage devices/servers (e.g., magnetic tape devices, hard disks, optical storage devices, etc.) with different processing speeds are used in the data repository. To reduce access times for accessing the backup data (e.g., restoring and/or recalling backup data), examples disclosed herein may be used to rebalance the backup data across the multiple storage servers from time to time based on, for example, how often files are accessed, the importance of the files, etc. By monitoring how often different catalog entries and/or files are accessed in a source server (e.g., a data source that was backed up), more frequently accessed files can be stored on faster processing storage servers during a rebalancing operation to improve access speeds while accessing backup copies of those frequently accessed files.

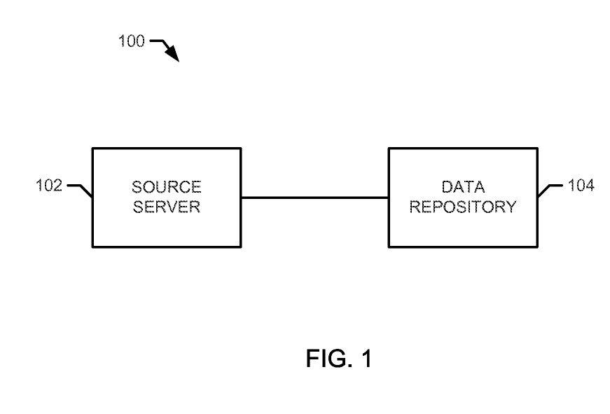

FIG. 1 illustrates an example data backup system 100 that may be used to implement examples disclosed herein. The example data backup system 100 includes a source server 102 and a data repository 104. In some examples, the source server 102 and/or the data repository 104 may include multiple devices. For example, the source server 102 (e.g., a data source to be backed up) may include disk arrays (e.g., a data storage system including multiple disk drives) or multiple workstations (e.g., desktop computers, workstation servers, laptops, etc.) in communication with one another and/or the data repository 104 may include multiple storage media and/or local servers such as magnetic tape devices, hard disks, optical storage devices, etc.

In the illustrated example, the source server 102 is in communication with the data repository 104. For example, the source server 102 may communicate with the data repository 104 via, for example, wired or wireless communications over, for example, a data bus, a Local Area Network (LAN), a wireless network, etc. As used herein, the phrase “in communication,” including variances, encompasses direct communication and/or indirect communication through one or more intermediary components. The example source server 102 operates in an online state and an offline state. While in the online state, the source server 102 may be accessed by clients for reading and/or writing. During a data backup process, when copying data from the example source server 102 to the example data repository 104, the example source server 102 is offline to enable taking a snapshot of the data being backed up at a particular time while none of the data is changing. For example, if a data backup process is performed while the example source server 102 is online, a file may be changed in a folder while the folder is being backed up. As a result, it would be unknown if the new version of that file was backed up partially, wholly, or not at all and, thus, may not be properly restorable later from the example data repository 104. Thus, a snapshot of the data refers to a copy of a static, non-changing state of all the files in a data source as of a particular date/time, similar to how a photograph captures a scene at a point in time.

In the illustrated example, after a copy or snapshot of the backup data is stored in the data repository 104, the source server 102 is put back online. In the illustrated example, when the example data repository 104 receives the copy or snapshot of the data, the example data backup system 100 may begin cataloging the backup data immediately or it may delay in cataloging the backup data until a later time. For example, the data backup system 100 may initiate cataloging the backup data during idle periods or at times of relatively low usage. In some examples, an adaptor may be installed in the example data backup system 100 to prioritize cataloging (e.g., creating catalog entries) the backup data relative to other backup data from other data sources and/or relative to other processes also being performed by the data repository 104. For example, data related to financial institutions may be cataloged prior to data from an end user. In other examples, backup data corresponding to frequently accessed files in a data source may be cataloged before other backup data. For example, a new version of an older file version already stored in the example data repository may be backed up earlier so it may be accessed if needed before the catalog generation is completed.

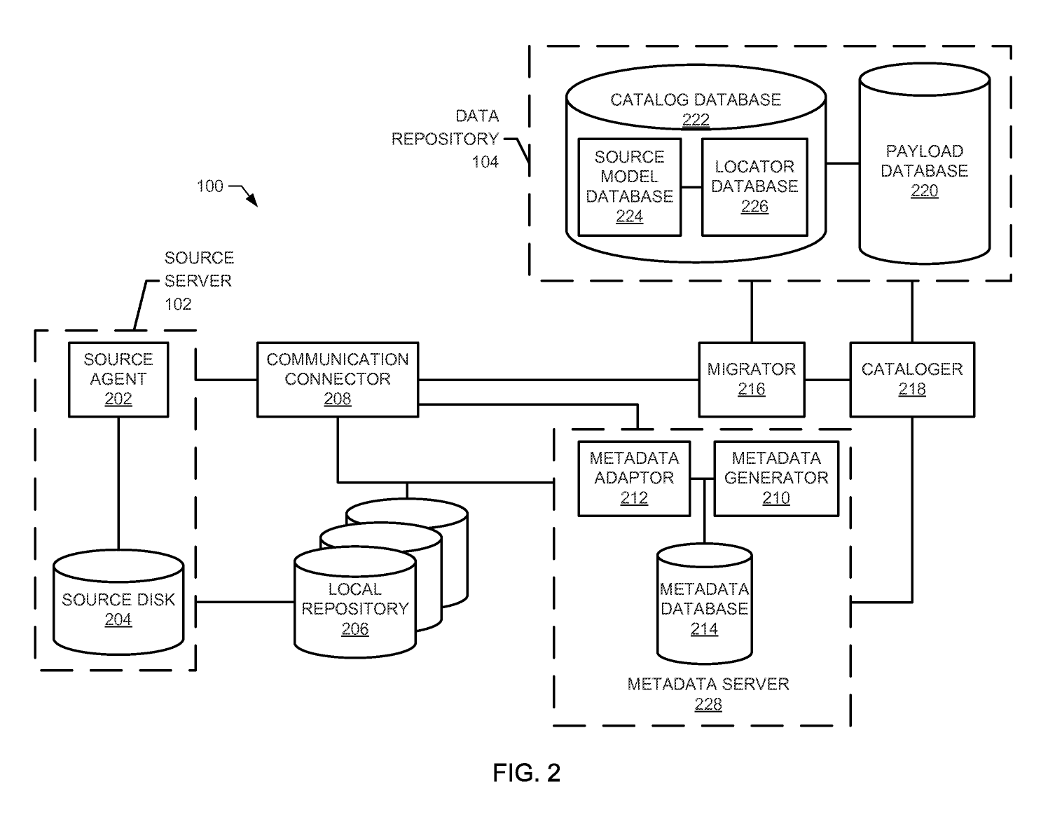

FIG. 2 is a detailed diagram of the example data backup system 100 of FIG. 1. In the illustrated example of FIG. 2, the source server 102 includes a source agent 202 and a source disk 204. The example source server 102 is in communication with the example data repository 104 via an example communication connector 208, an example migrator 216 and an example cataloger 218. Additionally and/or alternatively, the example source server 102 may be in communication with the example data repository 104 via an example local repository 206, an example metadata server 228 and the example cataloger 218. In the illustrated example of FIG. 2, the data repository 104 includes a payload database 220 in communication with a catalog database 222, which includes a source model database 224 and a locator database 226. The example metadata server 228 includes an example metadata generator 210 in communication with an example metadata adaptor 212 and an example metadata database 214.

In the illustrated example, the example storage source agent 202 provides a user interface to receive user inputs for generating data backup plans and monitoring progress of data backup processes. The source agent 202 is installed on a client resource such as the source server 102, and manages data backup processes of the client resource. In the illustrated example, the source disk 204 stores the data that is to be copied from the source server 102 and backed up. Through the source agent 202, a user may specify how often data backups are performed, what data and/or files should be backed up, what protocols to follow during the data backup process, what information regarding the data and/or files should be collected, etc.

In the illustrated example of FIG. 2, when a data backup process is initiated, the example source agent 202 places the example source server 102 offline so that the example source disk 204 is inaccessible. In this manner, files and/or data stored on the example source disk 204 cannot be modified, thereby reducing the likelihood of corrupt, damaged and/or incomplete backup data. Alternatively, instead of placing the source server 102 offline, the example source disk 204 may be set to operate in a read-only mode so that files may be read, but data may not be written to or modified in the source disk 204.

While the example source disk 204 is offline, the example source agent 202 makes a local copy or snapshot of the data stored on the example source disk 204. This local copy (or snapshot) represents the state of the source disk 204 at a point in time. In the illustrated example of FIG. 2, this snapshot is copied to a local repository such as the example local repository 206 for temporary storage during the data backup process. In the illustrated example, the local repository 206 is separate from but local to the source disk 204 (e.g., in communication with the source server 102 via local interfaces such as Universal Serial Bus (USB). FireWire, SCSI, etc.), whereas a remote repository (e.g., the data repository 104) is typically located at an off-site location and communicates with the source server 102 over long distances via, for example, Ethernet, iSCSI, optical and/or fiber channels, etc. In the illustrated example, the example local repository 206 acts as a holding stage for the backup data between the source server 102 and the example data repository 104. In the illustrated example, this is useful because copying large amounts of data from the example source disk 204 to the example data repository 104 can be very time consuming. For example, the data transfer speeds to a remote data repository may be longer than transferring the data to the local repository 206. Once the copy of the data is moved to the example local repository 206, copying of the data from the example source disk 204 is complete and there is no longer the risk of files changing or moving during the copy process. By copying the data from the example source disk 204 to the example local repository 206, the example source server 102 may be released from the data backup process and placed back online for user access faster than if the data was copied directly from the source disk 204 to the data repository 104.

In the illustrated example of FIG. 2, when data backup processes are initiated, the example source agent 202 creates a communication pathway via the example communication connector 208 to the example data repository 104 to transfer backup data from the local repository 206 to the example data repository 104, via the migrator 216 and while the example source server 102 is online. In the illustrated example, the communication connector 208 is implemented using a server. In some examples, the communication connector 208 creates a secure path from the example source server 102 to the example data repository 104. In some examples, the communication connector 208 communicates additional setup, configuration or control information from the example source agent 202 to be used during data backup processes. For example, the communication connector 208 may communicate configuration settings from the example source agent 202 to the example metadata server 228.

In the illustrated example, the example metadata server 228 communicates with the example source agent 202 via the example communication connector 208 and with the example local repository 206. In the illustrated example, the example metadata server 228 includes the example metadata generator 210 to generate metadata associated with the files and/or backup data in the example local repository 206. This generated metadata is used to categorize and/or catalog the files and/or data. The metadata may include names of files and/or directories, information regarding the file structure (e.g., directory hierarchy) of the backup data, location of the backup data in the example local repository 206 and/or the location of the backup data stored in the example data repository 104, file descriptions (e.g., categories), version histories, etc. As described in greater detail below in connection with the example catalog database 222 of the example data repository 104, the stored metadata may be used to locate a file from the example data repository 104. In some examples, the example metadata generator 210 processes the backup data from the example local repository 206 based on the configuration settings from the example source agent 202. In the illustrated example, the metadata generated by the metadata generator 210 is stored in the example metadata database 214.

In the illustrated example of FIG. 2, the metadata server 228 also includes the metadata adaptor 212 and the metadata database 214. The example metadata generator 210 is in communication with the example metadata adaptor 212 and the example metadata database 214. In the illustrated example, the example metadata adaptor 212 is adapted to process information received from the example local repository 206 and to send configuration information to the metadata generator 210 based on the processed information. The metadata adaptor 212 of the illustrated example includes filters to determine whether data is of high priority (e.g., frequently accessed, high importance, etc.), such as backup data from a financial institution. In some examples, the metadata adaptor 212 enables the example metadata generator 210 to process new types of information. For example, a new application may be installed at the example source server 102 and may store data files not recognized by the example metadata generator 210. In some such examples, a new and/or modified example metadata adaptor 212 may be installed in the example metadata server 228 to enable the example metadata generator 210 to recognize the data files being received.

In the illustrated example of FIG. 2, the example migrator 216 is in communication with the example communication connector 208 to copy data from the source server 102 and/or the local repository 206 to the example data repository 104.

In the illustrated example of FIG. 2, the example cataloger 218 generates a catalog of backup data based on information received from the example metadata server 228. The cataloger 218 creates a catalog entry for backup data received from the example source server 102 and/or the example local repository 206 and stores the catalog entries in the example catalog database 222 of the local repository 104. These catalog entries include information to locate files stored in the data repository 104 and/or identify properties of the stored files. For example, different versions of a file may be stored in the example data repository 104 and the corresponding catalog entry can identify the different versions of the files and the locations of the different versions in the data repository 104. In some examples, the example migrator 216 may perform additional translation services needed to further communicate with the example cataloger 218. For example, information received by the example migrator 216 may be encoded differently than what the example cataloger 218 expects. In some such examples, the example migrator 216 may act to translate the incoming information accordingly.

In the illustrated example, when the example cataloger 218 receives the copy or snapshot of the data, it may begin creating catalog entries immediately or it may delay creating catalog entries until later because the online source server 102 cannot modify (e.g., write to, delete, etc.) the backup data stored in the example local repository 206. For example, the cataloger 218 may initiate cataloging the backup data during idle periods or during times of relatively low usage. In some examples, the cataloger 218 may receive processed information from the example metadata adaptor 212 and/or the example source agent 202 indicating to prioritize cataloging operations (e.g., creating catalog entries) of some backup data before other backup data. For example, data from financial institutions require accessibility as soon as possible should its backup version need to be restored upon failure of the active version. That is, some financial information backup data needs to be accessible at virtually any moment. Thus, the example cataloger 218 may identify, based on metadata received from the example metadata database 214, which files are related to financial institutions. These files, accordingly, are immediately cataloged by the example cataloger 218 in some examples and copied to the example data repository 104. In some examples, backup data related to frequently accessed data may be cataloged before other backup data. Alternatively, the example cataloger 218 may catalog the backup data based on information received from the metadata database 214. For example, the example cataloger 218 may perform an incremental data backup based on the metadata associated with a file. For instance, comparing the last modified metadata associated with a file may indicate the file was not modified since the last data backup. Thus, rather than storing a new copy of the file to the example data repository 104, the example cataloger 218 may modify the associated metadata to indicate the current version of the file is the same as the last version. As a result, when either of the last two versions is recalled by the source server 102, the same version is returned and less space is used in the example data repository 104.

As described above in connection with the data backup process of FIGS. 1 and 2, backup data is stored in the example data repository 104. In the illustrated example of FIG. 2, the example data repository 104 includes a payload database 220 and a catalog database 222. In the illustrated example, the payload database 220 and the catalog database 222 are stored in a single storage server. In some examples, the catalog database 222 may be stored in a separate storage server than the payload database 220. In some examples, portions of the catalog database 222 may be stored with the payload database 220.

The example payload database 220 stores the backup data received from the example source server 102. That is, the example payload database 220 stores copies of the original data from the example source server 102. In the illustrated example, backup data stored in the example payload database 220 is cataloged via associated catalog entries or metadata stored in the example catalog database 222. These catalog entries enable faster access to files stored in the example payload database 220, especially as the amount of backup data stored in the data repository 104 increases. However, as the amount of backup data stored in the example payload database 220 increases, the amount of metadata in each catalog entry stored in the example catalog database 222 needed to locate a file also increases.

In the illustrated example, to better handle increased volumes of backup data in the payload database 220, the example catalog database 222 of FIG. 2 includes a tiered catalog including a source model database 224 and a locator database 226. That is, the example catalog database 222 and the corresponding catalog entries are divided into two levels to improve data access over prior systems. In the illustrated example, the catalog entries stored in the example source model database 224 keep track of the files received from the example source server 102 and the file system relationship between files stored in the example payload database 220. For example, the metadata in the catalog entries stored in the example source model database 224 maintain the file structure of the copy or snapshot of the example source disk 204 when backup processes were initiated. For instance, the catalog entries stored in the source model database 224 keep track of the folders and the various files in these folders. The number of items stored in the example source model database 224 is proportional to the number of items in the example source disk 204 and does not increase over time with each data backup. For example, rather than creating new catalog entries including redundant metadata of information known from previous data backup processes, the catalog entries in the source model database 224 are modified to reflect any new information (e.g., a new folder, a new version of a file, etc.). The catalog entries stored in the example source model database 224 also store pointers (e.g., metadata) to the example locator database 226.

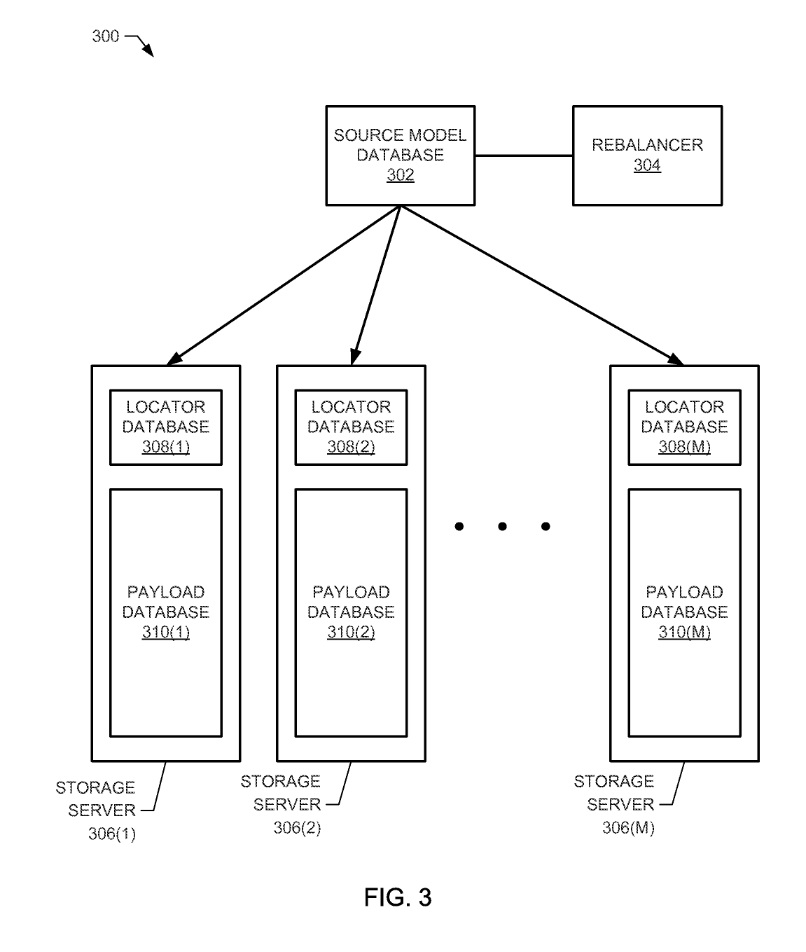

In the illustrated example, the catalog entries stored in the locator database 226 store mappings between files identified in the example source model database 224 and the locations of those files in the example payload database 220. In some examples, the catalog entries stored in the locator database 226 store mappings from files in the example source model database 224 to the different versions of those files stored in the example payload database 226. In some examples, different versions may be backed up for a single file because the file was modified at the source server 102 by a user between different instances of data backup processes. Thus, by using a tiered catalog database 222, the overall space needed to store catalog entries is reduced. Rather than creating a new catalog entry for each file received during data backup processes and with each catalog entry storing all the information needed to restore a file (e.g., location of the file in the payload database, the file hierarchy of the snapshot, etc.), the tiered catalog database 222 divides the catalog entries to optimize locating a file in the payload database 220 while reducing the space needed in the catalog database 222 to store the catalog entries. As described in connection to FIG. 3, examples disclosed herein further improve data backup processes over prior systems by distributing the example locator database 226 over several storage devices in the data repository 104 such as, for example, in a distributed data repository.

FIG. 3 illustrates an example distributed data repository 300 that may be used in connection with the data backup system 100 of FIGS. 1 and 2. In some examples, the distributed data repository 300 may be used to implement the data repository 104 of FIGS. 1 and 2. As described above, a data repository may include multiple storage media, such as, for example, multiple storage servers that store the backup data. In some examples, the example storage servers that form the example distributed data repository 300 may process data at different speeds. For example, while magnetic tape media store larger amounts of data than storage disks, magnetic tape media process data slower than storage disks.

In the illustrated example, the example distributed data repository 300 is distributed across M storage servers 306(1), 306(2) . . . , 306(M). Each example storage server 306(1)-306(M) includes a corresponding locator database 308(1)-308(M) and a corresponding payload database 310(1)-310(M), respectively. Thus, the example catalog database 222 of FIG. 2 is stored in a distributed fashion across the multiple storage servers 306(1)-306(M) in the example distributed data repository 300 as the locator databases 308(1)-308(M). In addition, the payload database 220 of FIG. 2 is implemented as distributed stores across the storage servers 306(1)-306(M) as the payload databases 310(1)-310(M). In the illustrated example, the example rebalancer 304 communicates with the source model database 302. In the illustrated example, the source model database 302 may replace or be used to implement the example source model database 224 of FIG. 2.

Each storage server 306(1)-306(M) in the illustrated example processes data at a different speed. In the illustrated example of FIG. 3, each storage server processes data relatively faster than the storage server on its right. For example, the storage server 306(1) processes data relatively faster than the storage servers 306(2)-306(M). In some such examples, the storage servers 306(1)-306(M) in the example distributed data repository 300 may be organized according to a hierarchy based on storage server speed. For example, storage server 306(1) of the illustrated example is a tier 1 server, and storage server 306(2) of the illustrated example is a tier 2 server. In some examples, multiple storage servers may process data at the same speed and be in the same server tier.

In the illustrated example of FIG. 3, by distributing the example locator database 226 of FIG. 2 across multiple storage servers as the locator databases 308(1)-308(M), each locator database 308(1)-308(M) and its corresponding payload database 308(1)-308(M) stores and maps only a portion of backup data from a source server (e.g., the example source server 102 of FIGS. 1 and 2). Thus, rather than having one locator database to store mappings to all files (e.g., catalog entries) in the source model database 302 to the locations of the files in the payload database, each of the example locator databases 308(1)-308(M) only stores information to the corresponding example payload database 310(1)-310(M). As a result, the size of the example source model database 302 of FIG. 3 remains proportional to the amount of data backed up from the example source server 102, and each example locator database 308(1)-308(M) and corresponding example payload database 310(1)-310(M) stores only a portion of the backup data.

In some examples, to further optimize access times of the distributed data repository 300, the backup data stored in each storage server 306(1)-306(M) (e.g., the catalog entries stored in example locator databases 308(1)-308(M) and the corresponding backup data stored in the example payload databases 310(1)-310(M)) is determined based on the priority of the backup data. For example, the cataloger 218 of FIG. 2 may embed metadata in catalog entries identifying the priorities of backup data. In some examples, newly backed up data has a relatively higher likelihood of being accessed using a restore process than older data. Thus, in some examples, newly backed up data is stored in relatively faster storage servers (e.g., the example storage server 306(1)). In other examples, backed up data may be distributed for storage among the storage servers 306(1)-306(M) based on type (or properties) of data. For example, financial institution data may be deemed higher priority than end user data and, thus, backed up financial institution data may be stored on relatively faster storage servers (e.g., the storage server 306(1)), and end user data may be stored on relatively slower storage servers (e.g., the storage servers 306(2)-306(M)). As higher priority files have a higher probability of being accessed, the files stored on the relatively faster storage servers (e.g., the storage server 306(1)) need to be able to be quickly accessed. To do so, the corresponding locator database (e.g., the example locator database 308(1)) may index the backup data in the corresponding payload database (e.g., the example payload database 310(1)). In the illustrated example, an indexed database (e.g., the indexed storage server 306(1) and corresponding indexed payload database 310(1)) includes a data structure (e.g., a table, a bit array, etc.) that improves data lookup or data access of data stored in the database. For example, indexing the payload database 310(1) enables filtering data (e.g., querying only image files) stored in the indexed payload database 310(1). Thus, the catalog entries stored in the example locator database 308(1) include additional metadata so that any file stored in the corresponding example indexed payload database 310(1) can be located (e.g., accessed) relatively faster. On the other hand, files stored in the relatively slower storage servers (e.g., storage servers 306(2)-306(M)) may be rarely, if ever, accessed. Thus, indexing the relatively slower storage servers (e.g., storage server 306(2)-306(M)) would result in storage space being used to quickly access files that have a lower probability of being accessed and are, therefore, not indexed. Thus, the data stored in these non-indexed databases (e.g., non-indexed storage servers 306(2)-306(M) and corresponding non-indexed payload databases 310(2)-310(M)) is stored as large entities of non-filtered data (e.g., binary large objects (BLOBs)).

In the illustrated example of FIG. 3, the catalog entries stored in the example locator databases of the relatively slower storage servers (e.g., locator databases 308(2)-308(M)) store minimal metadata associated with the files stored in the corresponding payload databases (e.g., payload databases 310(2)-310(M)). In some examples, metadata stored in locator databases in the relatively slower storage servers is only metadata characterizing the properties of files stored in the corresponding payload databases. For example, backup data last modified during a time period is stored in the payload database. As the backup data stored in the relatively slower payload databases is not indexed, the backup data in the relatively slower payload databases (e.g., non-indexed payload databases 310(2)-310(M)) is stored as BLOBs. Therefore, the storage space of the relatively slower storage servers is more efficiently used in the example distributed data repository 300 than storage space in prior systems.

In some examples, backed up data may be distributed across the multiple storage servers 306(1)-306(M) based on historical restore patterns. For example, the rebalancer 304 may be in communication with the example source model database 302. In the illustrated example, the example rebalancer 304 monitors how frequently backup data is accessed (e.g., recalled and/or restored) between data backups. For example, certain files may be accessed more frequently than others over a period of time. In some such instances, access times for the more frequently accessed files may be improved by storing those files in the relatively faster processing servers for faster access. In the illustrated example, the example rebalancer 304 keeps track of how frequently each file from the example payload databases 310(1)-310(M) is accessed. In some examples, the backup data stored in the example storage servers 306(1)-306(M) during data backup processes is redistributed based on the information received from the example rebalancer 304. For example, if the rebalancer 304 detects that some files stored in the example storage server 306(2) are accessed more frequently than some files stored in the example storage server 306(1), the example source model database 302 may move the more frequently accessed files from the example storage server 306(2) to the example storage server 306(1) based on analysis results of the rebalancer 304 relating to how often the files are accessed. When files are redistributed based on the access frequency determined by the example rebalancer 304, files moved to the relatively faster storage servers (e.g., storage server 306(1)) are indexed by the corresponding locator database (e.g., locator database 308(1)), and the corresponding catalog entries are updated to include metadata associated with the locations of files moved to the relatively faster storage server.

FIGS. 8A, 8B and 8C illustrate another example implementation of backup data distribution in the distributed data repository 300. FIG. 8A shows a snapshot of backup data stored in a tier 1 storage server (e.g., an example indexed storage server 806(1)) and a tier 2 storage server (e.g., an example non-indexed storage server 806(2)) at a first point in time. FIG. 8B shows a snapshot of the backup data stored in the example indexed storage server 806(1) and the example non-indexed storage server 806(2) after the backup data has been redistributed according to feedback received from the rebalancer 304 (FIG. 3). FIG. 8C shows a snapshot of the backup data stored in the example indexed storage server 806(1) and the example non-indexed storage server 806(2) after a second redistribution. In the illustrated example, the storage server 806(1) includes an example locator database 808(1) storing backup data such as, for example, catalog entries (e.g., catalog entries M1.1, M2.1, etc.) and an example payload database 810(1) storing backup data such as, for example payload data (e.g., payload data P1, P2, etc.), and the storage server 806(2) includes an example locator database 808(2) storing backup data such as, for example, catalog entries (e.g., catalog entries M4.1, M5.1, etc.) and an example payload database 810(2) storing backup data such as, for example payload data stored as blobs (e.g., blobs B4, B5, etc.).

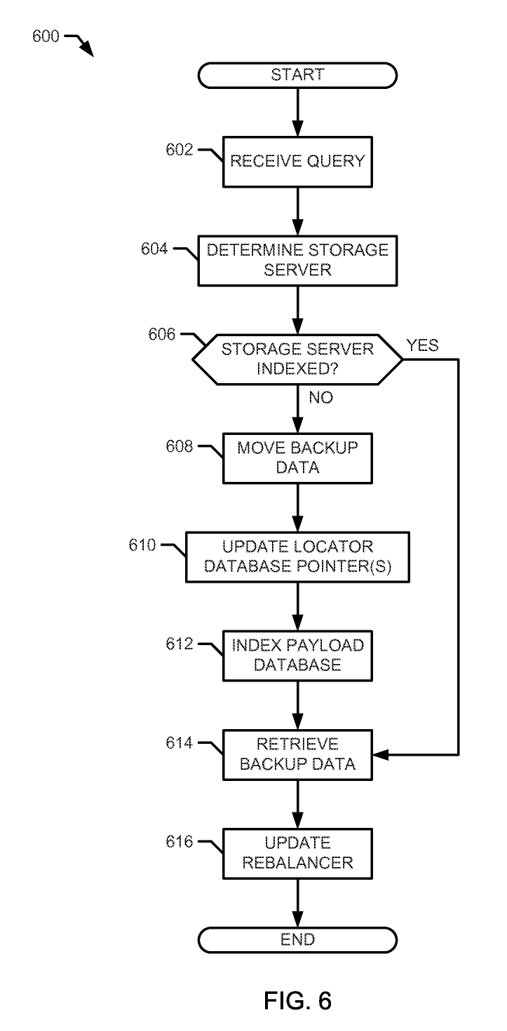

In the illustrated example of FIG. 8A, payload data (e.g., the payload P1, the payload P2 and the payload P3) stored in the payload database 810(1) includes indexable data or files (e.g., the file P1.a, the file P1.b, the file P2.a, etc.). Data or files in the payload data are identifiable by the corresponding catalog entries (e.g., catalog entries M1.1, M1.2, M2.1, etc.) stored in the corresponding locator database 808(1). For example, the catalog entry M1.1 may store metadata to identify that a file is stored in the payload P1 and the metadata stored in the catalog entry M1.2 may be indexed metadata (e.g., the types or properties of the files such as the author of a document, a change log, etc.) that enables filtering the files in the payload P1 (e.g., the file P1.a, the file P1.b) to locate (e.g., access) a queried file stored in the payload database 810(1) relatively faster. Similarly, the catalog entry M3.3 may store additional indexed metadata (e.g., types or properties of files such as the author of a document, a change log, etc.) extracted from the payload P3. As described in connection with the relatively slower storage servers (e.g., the example indexed storage server 306(2) of FIG. 3), the payload data is stored as blobs (e.g., B4, B5 and B6) in the payload database 810(2) and the corresponding catalog entries (e.g., the catalog entries M4.1, M5.1 and M6.1) stored in the corresponding locator database 810(2) identify the files stored in the payload database 810(2). However, the example catalog database 808(2) does not include indexed metadata and, as a result, a specific file, such as the file P3.b, cannot be located. FIGS. 8B and 8C illustrate snapshots of the content stored in the example storage server 806(1) and the example storage server 806(2) after a first redistribution (FIG. 8B) and after a second redistribution (FIG. 8C). In the illustrated example, data or files stored in the blobs B6 and B4 (FIG. 8A) were accessed relatively more frequently than the data or files stored in the payload P1 and the payload P3. Thus, the example source model database 302 of FIG. 3 moves the data (e.g., the example payloads P and P3 and the example blobs P4 and P6), as shown in FIG. 8B. In addition to updated the payload databases (e.g., the example payload database 810(1) and the example payload database 810(2)), the locator database (e.g., the example locator database 808(1) and the example locator database 808(2)) are also updated. For example, the payload data or files stored in blob B6 (e.g., the file P6.a, the file P6.b) are indexed and corresponding catalog entries (e.g., catalog entries M6.2, M6.3) are created and stored in the locator database 808(1). Likewise, the backup data stored in the relatively slower storage server 808(2) is updated. For example, the catalog entries to identify the files in the payload P1 and the payload P3 (e.g., the catalog entry M1.1 and the catalog entry M3.1) are moved to the example locator database 808(2). However, to prevent the storage space used to store metadata in the locator database (e.g., the example locator database 808(2)) from continuously growing after each redistribution, the indexed metadata is moved into the corresponding payload database (e.g., the example payload database 810(2)). For example, the indexed metadata M3.2 and M3.3 is stored in the blob B3 along with the corresponding payload data (e.g., the payload P3) in the example payload database 810(2). Thus, the catalog entry M3.1 indicates the file P3.a is included in the payload P3 and is stored in the blob B3. However, no additional information regarding the file (e.g., the type or properties of the file, etc.) is provided, and the file (i.e., the file P3.a) is not accessible in the instance of a restore command. Rather, as described in greater detail in connection with FIG. 6, the payload P3 is first moved to the indexed storage server 806(1), and then the file P3.a is located (e.g., accessed) by identifying the corresponding catalog entry (i.e., the catalog entries M3.1, M3.2 and/or M3.3).

Storing indexed metadata in a payload database prevents locator databases from growing in storage space over time. As a result, the storage space used by locator databases in the distributed data repository 300 remains relatively fixed over time and is proportional to the number of items stored in the source disk (e.g., the example source disk 204 of FIG. 2). However, the storage space used by locator databases may be changed based on changing conditions of the distributed data repository 300. For example, adding a larger storage disk enables using more space for the locator databases.

In addition to keeping sizes of locator databases relatively the same over time, storing indexed metadata in the payload database 810(2) enables relatively faster indexing of the example payload database 810(1) when data is moved into the payload database 810(1). For example, the illustrated example of FIG. 8C shows a snapshot of the example storage server 808(1) and the example storage server 808(2) after a second redistribution of the backup data (e.g., the payload data and the corresponding catalog entries). Specifically, the example of FIG. 8C illustrates that when the blob B3 is moved from the example non-indexed storage server 806(2) (FIG. 8B) to the example indexed storage server 806(1) (FIG. 8C), the data and files of payload P3 (e.g., the example files P3.a. P3.b) are moved to the corresponding payload database 810(1) and the previously indexed metadata (e.g., indexed metadata stored in the example catalog entries M3.2, M3.3) is identified (e.g., located) in the blob B3 (FIG. 8B) and stored in the corresponding locator database 808(1) (FIG. 8C). Thus, the data or files included in the blob B3 do not need to be indexed again. When the payload P4 is moved to the tier 2 storage server (e.g., the payload database 810(2)), the indexed metadata corresponding to the payload P4 (e.g., the catalog entry M4.2) is stored with the payload P4 in the blob B4 in the example payload database 810(2) of the example non-indexed storage server 806(2). In some examples, a portion or all of the payload data stored in the example payload database 810(1) may be indexed after redistribution.

While example manners of implementing the data backup system 100 have been illustrated in FIGS. 1-3, one or more of the elements, processes and/or devices illustrated in FIGS. 1-3 may be combined, divided, re-arranged, omitted, eliminated and/or implemented in any other way. Further, the example source server 102, the example data repository 104, the example source agent 202, the example source disk 204, the example local repository 206, the example communication connector 208, the example metadata generator 210, the example metadata adaptor 212, the example metadata database 214, the example migrator 216, the example cataloger 218, the example payload database 220, the example catalog database 222, the example source model database 224, the example locator database 226, the example source model database 302, the example rebalancer 304, the example storage servers 306(1)-306(M), the example locator databases 308(1)-308(M), the example payload databases 310(1)-310(M) and/or, more generally, the example data backup system 100 of FIGS. 1-3 may be implemented by hardware, software, firmware and/or any combination of hardware, software and/or firmware. Thus, for example, any of the example source server 102, the example data repository 104, the example source agent 202, the example source disk 204, the example local repository 206, the example communication connector 208, the example metadata generator 210, the example metadata adaptor 212, the example metadata database 214, the example migrator 216, the example cataloger 218, the example payload database 220, the example catalog database 222, the example source model database 224, the example locator database 226, the example source model 302, the example rebalancer 304, the example storage servers 306(1)-306(M), the example locator databases 308(1)-308(M), the example payload databases 310(1)-310(M) and/or, more generally, the example data backup system 100 of FIGS. 1-3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example source server 102, the example data repository 104, the example source agent 202, the example source disk 204, the example local repository 206, the example communication connector 208, the example metadata generator 210, the example metadata adaptor 212, the example metadata database 214, the example migrator 216, the example cataloger 218 the example payload database 220, the example catalog database 222, the example source model database 224, the example locator database 226, the example source model 302, the example rebalancer 304, the example storage servers 306(1)-306(M), the example locator databases 308(1)-308(M) and/or the example payload databases 310(1)-310(M) are hereby expressly defined to include a tangible computer readable storage medium such as a memory, DVD, CD, Blu-ray, etc. storing the software and/or firmware. Further still, the example data backup system 100 of FIGS. 1-3 may include one or more elements, processes and/or devices in addition to, or instead of, those illustrated in FIGS. 1-3, and/or may include more than one of any or all of the illustrated elements, processes and devices.

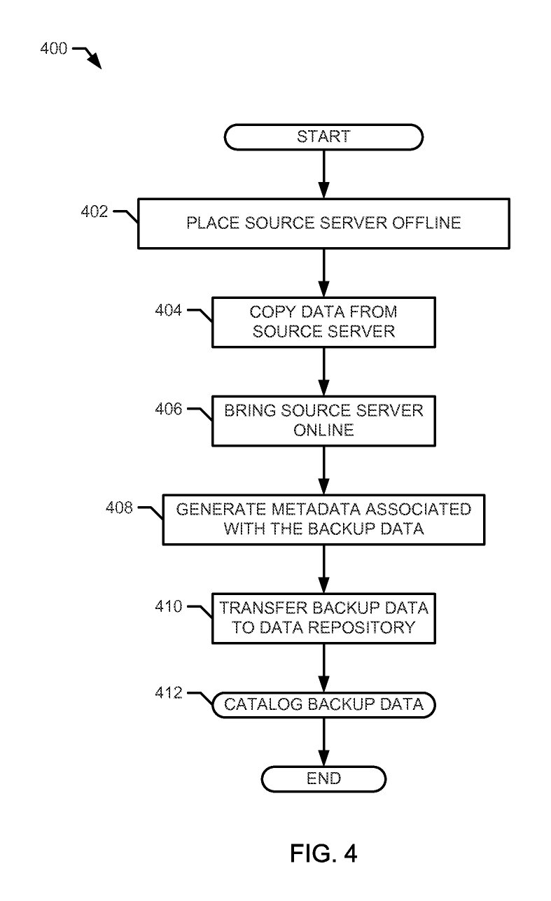

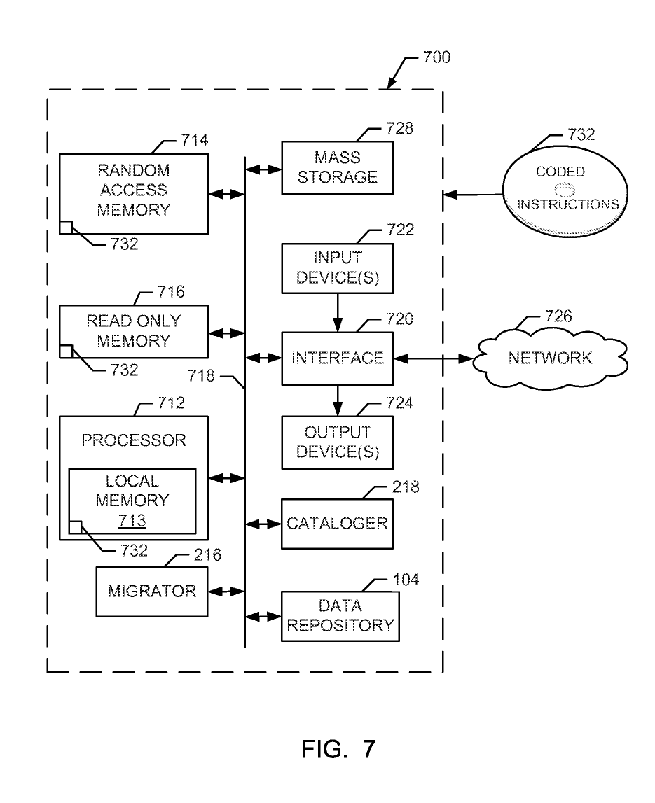

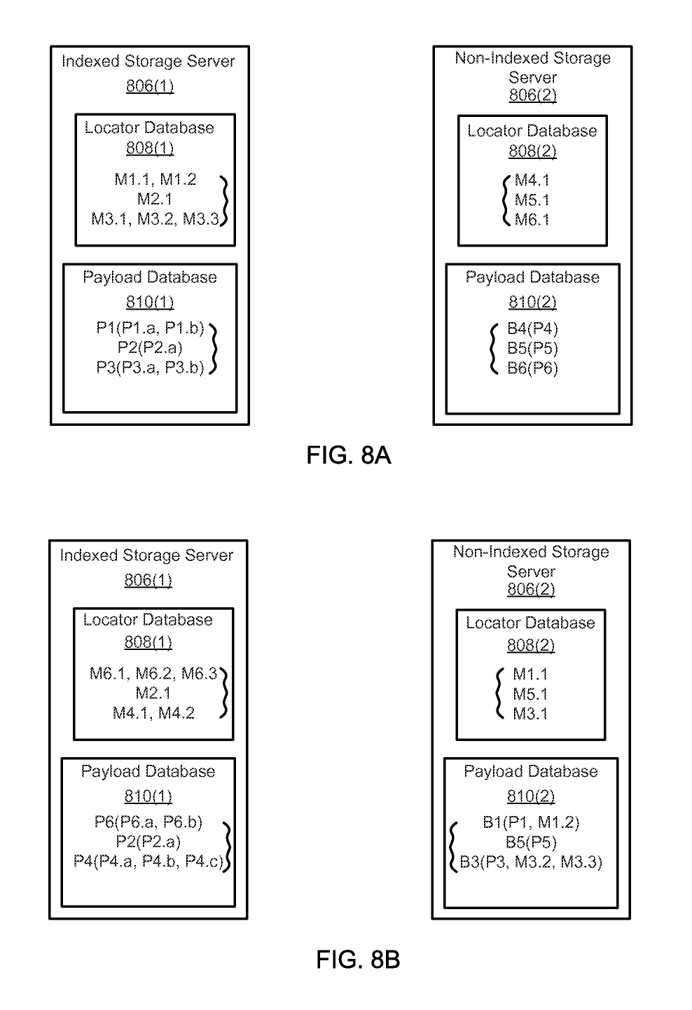

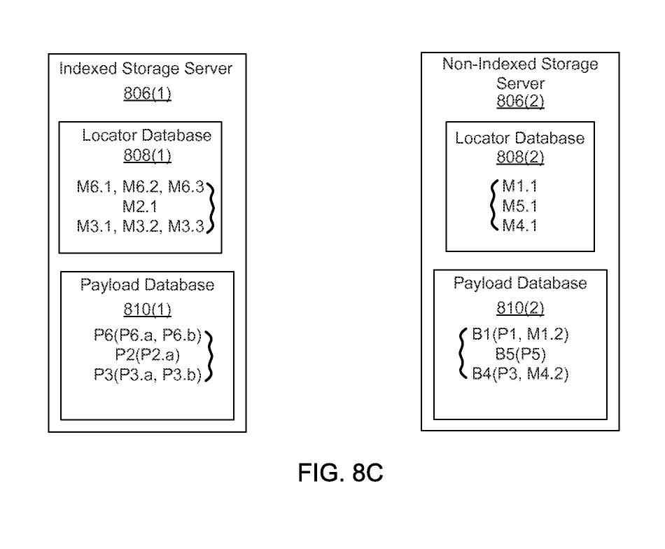

Flowcharts representative of example machine readable instructions for implementing the data backup systems of FIGS. 1-3 are shown in FIGS. 4-6. In these examples, the machine readable instructions comprise a program for execution by a processor such as the processor 712 shown in the example computer 700 discussed below in connection with FIG. 7. The program may be embodied in software stored on a tangible computer readable medium such as a CD-ROM, a floppy disk, a hard drive, a digital versatile disk (DVD), a Blu-ray disk, or a memory associated with the processor 712, but the entire program and/or parts thereof could alternatively be executed by devices other than the processor 712 and/or embodied in firmware or dedicated hardware. Further, although the example programs are described with reference to the flowcharts illustrated in FIGS. 4-6, many other methods of implementing the example data backup system of FIGS. 1-3 may alternatively be used. For example, the order of execution of the blocks may be changed, and/or some of the blocks described may be changed, eliminated, or combined.

As mentioned above, the example processes of FIGS. 4-6 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage and to exclude propagating signals. Additionally or alternatively, the example processes of FIGS. 4-6 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program of FIG. 4 begins at block 402 at which the source agent 202 (FIG. 2) places the source server 102 (FIGS. 1 and 2) offline. For example, the data on the source disk 204 (FIG. 2) of the example source server 102 is locked and inaccessible to users or other processes. At block 404, the local repository 104 (FIGS. 1 and 2) copies data from the example source server 102. In the illustrated example, the data copied from the source server 102 represents a static, non-changing state of the data at a particular moment in time (e.g., a snapshot).

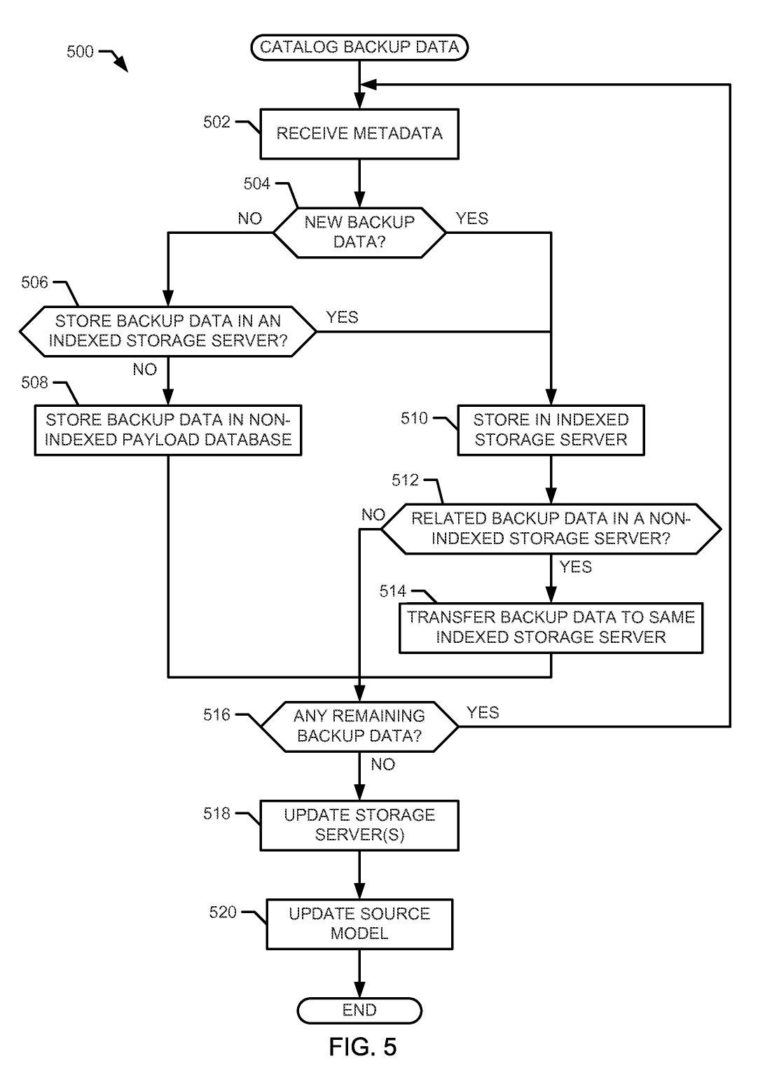

At block 406, the source agent 202 brings the example source server 102 and its associated source disk 204 back online. That is, the source disk 204 is unlocked, and access to files stored therein is restored for users and other processes. At block 408, the metadata generator 210 (FIG. 2) generates metadata associated with the copied data (e.g., backup data). For example, the generated metadata may include the file structure of the backup data, the file names of the backup data, the location of the backup data, etc. At block 410, the migrator 216 (FIG. 2) transfers the backup data and associated metadata to the example data repository 104. In some examples, instead of first copying the backup data to the local repository 206 (FIG. 2) as an intermediate step, the source disk 204 copies the backup data directly to the data repository 104 (e.g., copied to the payload database 220 (FIG. 2)) from the source disk 204. At block 412, the cataloger 218 (FIG. 2) catalogs the backup data. An example process that may be used to implement block 412 is described in detail in connection to FIG. 5. The example process of FIG. 4 then ends.

FIG. 5 illustrates a flow chart for an example method or process 500 to catalog backup data in a distributed data repository (e.g., the distributed data repository 300 of FIG. 3). In some examples, the example process 500 may be used to implement block 412 of FIG. 4. The example process 500 begins at block 502 at which the example cataloger 218 (FIG. 2) receives metadata from the example metadata database 214 (FIG. 2). At block 504, the example cataloger 218 determines whether the metadata is associated with new backup data. For example, metadata associated with new backup data is metadata corresponding to a new file or a new version of a file previously stored in the example data repository 104 (FIGS. 1 and 2). Metadata not associated with new backup data is metadata corresponding to an unmodified file previously stored in the example data repository 104. When the metadata does not correspond to a new file/version of a file, at block 506, the example rebalancer 304 (FIG. 3) scans the metadata to determine whether the corresponding backup data should be stored in an indexed storage server (e.g., the storage server 306(1) of FIG. 3) with an indexed payload database (e.g., the payload database 310(1) of FIG. 3). For example, the rebalancer 304 determines whether the metadata indicates that corresponding files are relatively frequently accessed files or high-priority files (e.g., relatively important files). If the rebalancer 304 determines that the backup data should not be stored in an indexed server (block 506), the example migrator 216 (FIG. 2) stores the backup data in a payload database (e.g., payload databases 310(2)-310(M)) that is not indexed (block 508).

When the metadata corresponds to new backup data (e.g., a new file/version of a file) (block 504), or when the rebalancer 304 determines that the backup data should be stored in an indexed storage server (block 506), the example migrator 216 stores the backup data in an indexed storage server (block 510) with an indexed payload database (e.g., the indexed payload database 310(1) of the corresponding indexed storage server 306(1)). In the illustrated example, the example migrator 216 stores a new file/version of a file or a relatively high-priority file in a tier 1 server (e.g., the indexed storage server 306(1)). At block 512, the rebalancer 304 determines whether any backup data related to the backup data stored in the indexed storage server is stored in any non-indexed storage server. For example, the rebalancer 304 may scan metadata corresponding to backup data stored in non-indexed payload databases to identify any backup data related to the newly stored backup data in the indexed payload database. For example, a file from the same directory as the new backup data may be stored in a non-indexed payload database but may have a higher likelihood of being accessed due to its same directory relation to a new file/version of a file and/or relatively high-priority file. If the rebalancer 304 finds related backup data in a non-indexed storage server, the migrator 216 transfers and stores the related backup data in the same indexed storage server (block 514) as the new backup data stored at block 510.

At block 516, the example cataloger 218 determines if any more files (e.g., backup data) are to be cataloged. If more backup data remains to be cataloger (block 516), control returns to block 502. If the cataloger 218 determines that there is not any backup data remaining to be cataloged (block 516), the backup data has been copied to the data repository 104 and the example cataloger 218 updates the storage servers (block 518) to reflect the backup data stored in the storage servers. For example, the example cataloger 218 indexes the example payload database 310(1), and stores the location of files as metadata in the corresponding catalog entries in the corresponding example locator database 308(1). Additionally, the example cataloger 218 removes any non-relevant metadata (e.g., metadata identifying the location of files in the payload database) stored in the corresponding locator database. In some examples, the example cataloger 218 moves the non-relevant metadata from the corresponding locator database to the corresponding payload database, thereby maintaining the size of the locator databases over time. At block 520, the example cataloger 218 updates the source model database 302 (FIG. 3). For example, the example cataloger 218 updates the example source model database 302 to identify locator databases corresponding to the catalog entries. The example process of FIG. 5 then ends.

FIG. 6 illustrates a flow chart for an example method or process 600 to query a file in a distributed data repository (e.g., the distributed data repository 300 of FIG. 3). The example program 600 begins at block 602 at which the example data repository 104 (FIGS. 1 and 2) receives a request (e.g., a query) for a file from, for example, the example source server 102 (FIGS. 1 and 2). For example, the request may be to restore a file from the example data repository 104. At block 604, the example cataloger 218 (FIG. 2) determines which storage server (e.g., the storage servers 306(1)-306(M)) stores the file. For example, the cataloger 218 scans metadata stored in the source model database 302 (FIG. 3) indicating the locator database corresponding to the storage server storing the queried file. At block 606, the example cataloger 218 determines whether the storage server storing the file is indexed (e.g., includes an indexed payload database). If the payload database is indexed (e.g., the file is stored in the indexed storage server 306(1)) (block 606), control advances to block 614.

On the other hand, if the file is stored in a non-indexed payload database (e.g., the payload databases 310(2)-310(M) corresponding to the storage servers 306(2)-306(M)) (block 606), the non-indexed payload database stores the files as a BLOB and the location of the file is not stored as metadata in the catalog entries in the corresponding locator database. In some examples, the file may have been moved from the storage server that the example source model database 302 references (e.g., points to). For example, between two data backups, the example source server 102 queries a file that the example source model database 302 indicates is located in a relatively slower storage server (e.g., the storage servers 306(2)-306(M)) but has moved to a relatively faster storage server (e.g., the storage server 306(1)). In some such examples, the example cataloger 218 updates the pointers (stored as metadata in the locator database) corresponding to the correct location of the file, but the example cataloger 218 does not update the example source model database 302 to reduce processing time at the distributed data repository 300.

At block 608, the example migrator 216 moves the corresponding backup data (e.g., the BLOB) to an indexed storage server including an indexed payload database. For example, the migrator 216 moves a BLOB stored in the example non-indexed payload database 310(2) to the example indexed payload database 310(1). At block 610, the example cataloger 218 updates the metadata stored in the affected locator databases. For example, the cataloger 218 adds pointers (e.g., metadata) to the example locator database 308(1) when the BLOB is moved to the example indexed payload database 310(1), and the example cataloger 218 removes any metadata stored in the example non-indexed payload database 310(2) from which the data was moved. In some examples, the example cataloger 218 moves the metadata associated with indexing (e.g., pointers) to the example non-indexed payload database 310(2). At block 612, the example cataloger 218 indexes the payload database in which the BLOB was stored at block 608.

When indexing the payload database 310(1) is completed (block 612), or if the cataloger 218 determines that the storage server storing the file is indexed (block 606), the example migrator 216 retrieves the queried file using the stored metadata (block 614). At block 616, the example rebalancer 304 (FIG. 3) updates its information regarding backup data stored in the distributed data repository 300. For example, the example rebalancer 304 updates a counter corresponding to the accessed file. The example process of FIG. 6 then ends.

FIG. 7 is a block diagram of an example computer 700 capable of executing the instructions of FIGS. 4-6 to implement the data backup system of FIGS. 1-3. The computer 700 can be, for example, a server, a personal computer, an Internet appliance, or any other type of computing device.

The system 700 of the instant example includes a processor 712. For example, the processor 712 can be implemented by one or more microprocessors or controllers from any desired family or manufacturer.

The processor 712 includes a local memory 713 (e.g., a cache) and is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller. In the illustrated example, access to the data repository 104 is controlled by the migrator 216 and cataloger 218.

The computer 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer and/or speakers). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The computer 700 also includes one or more mass storage devices 728 for storing software and data. Examples of such mass storage devices 728 include floppy disk drives, hard drive disks, compact disk drives and digital versatile disk (DVD) drives. The mass storage device 728 may implement a local storage device.

Coded instructions 732 representative of the machine readable instructions of FIGS. 4-6 may be stored in the mass storage device 728, in the volatile memory 714, in the non-volatile memory 716, and/or on a removable storage medium such as a CD or DVD.

From the foregoing, it will appreciate that the above disclosed methods, apparatus and articles of manufacture increase the efficiency during data backup and improve backup data access times.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method of cataloging backup data comprising:
when a source server is offline, copying the backup data to a data repository from the source server;
in response to completing copying of the backup data, putting the source server online; and
cataloging the backup data in the data repository when the source server is online to complete backup of the backup data to the data repository.

2. A method as defined in claim 1, further comprising placing the source server offline when a backup process is initiated at the source server.

3. A method as defined in claim, wherein copying the backup data to the data repository further comprises:
copying the backup data to a local repository when the source server is offline;
putting the source server online when the copying of the backup data to the local repository is complete; and
moving the backup data from the local repository to the data repository when the source server is online.

4. A method as defined in claim 1, wherein the backup data includes metadata and payload data, the metadata describing parameters of the payload data.

5. A method as defined in claim 4, wherein the data repository includes a plurality of storage servers, the plurality of storage servers including at least a first storage server in a first tier and at least a second storage server in a second tier.

6. A method as defined in claim 5, wherein the first storage server in the first tier processes data faster than the second storage server in the second tier, and wherein the backup data stored in the first storage server in the first tier is indexed.

7. A method as defined in claim 5, wherein cataloging the backup data in the data repository further comprises:
storing in a source model database in the first storage server at least one pointer that maps a source file to corresponding backup files in a locator database in a corresponding one of the storage servers, each locator database including metadata associated with the backup data in the storage server; and
monitoring in a rebalancer how often backup data in the data repository is accessed by the source server, the rebalancer located in the first storage server.

8. A method as defined in claim 7, wherein each locator database includes metadata and a pointer to the location of the backup data in the storage server.

9. A method as defined in claim 8, wherein the metadata stored in the second storage server in the second tier includes less information than the metadata stored in the storage server in the first tier.

10. A method as defined in claim 7, wherein the rebalancer moves backup data associated with less frequent accesses to one of the storage servers that processes data relatively slower, and moves backup data associated with the more frequent accesses from a slow storage server to another one of the storage servers that processes data relatively faster.

11. An apparatus comprising:
a data repository to receive backup data of data from a source server while the source server is offline, the data repository further comprising:
a cataloger to catalog the backup data in the data repository when the source server is online; and
a rebalancer to monitor frequencies of data accesses associated with the backup data in the data repository.

12. The apparatus as defined in claim 11, wherein the data repository further comprises:
a plurality of storage servers, the plurality of storage servers to include at least a first storage server in a first tier and at least a second storage server in a second tier;
a source model database to store at least one pointer that maps a source file to corresponding backup files in a locator database in one of the storage servers, each storage server to include a payload database storing backup data and a locator database storing metadata associated with the backup data in the storage server;
a rebalancer to move backup data associated with less frequent accesses to one of the storage servers that processes data relatively slower; and
the rebalancer to move backup data associated with more frequent accesses from a slow storage server to another one of the storage servers that processes data relatively faster.

13. The apparatus as defined in claim 12, wherein the metadata stored in the second storage server in the second tier includes less information than the metadata stored in the storage server in the first tier.

14. A tangible computer readable storage medium comprising instructions that when executed cause a machine to at least:
copy backup data to a data repository from data at a source server when the source server is offline;
bring the source server online when copying the backup data is complete; and
catalog the backup data in the data repository while the source server is online to complete backup of the backup data on the data repository.

15. The tangible computer readable storage medium according to claim 14, wherein the instructions further cause the machine to:
store in a source model database in a first storage server at least one pointer that maps a source file to corresponding backup files in a locator database in one of a plurality of storage servers, each storage server including a payload database storing backup data and each locator database storing metadata associated with the backup data in the corresponding storage server:
determine frequencies of accesses associated with the backup data in the data repository; and
move backup data associated with less frequent accesses to one of the storage servers that processes data relatively slower, and move backup data associated with more frequent accesses from a slow storage server to another one of the storage servers that processes data relatively faster.
